(19) United States
(12) Patent Application Publication
(10) Pub. No.: US 2026/0240715 A1
(43) Pub. Date: Aug. 20, 2026

(54) VARIABLE WEIGHTED MASSAGE ROLLER AND METHODS OF MAKING AND USING SAME

(71) Applicant: Sharon Klinger, Auburn, PA (US)

(72) Inventor: Sharon Klinger, Auburn, PA (US)

(21) Appl. No.: 19/646,685

(22) Filed: Apr. 14, 2026

Related U.S. Application Data
(63) Continuation-in-part of application No. 17/892,596, filed on Aug. 22, 2022, now abandoned.
Application No. 17/892,596 is a continuation-in-part of application No. 29/611,535, filed on Jul. 21, 2017, now Pat. No. D961791.

(51) Int. Cl. A61H 15/00

(52) U.S. Cl. CPC A61H 15/0092; A61H 2015/0014

(57) ABSTRACT

A variable weighted massage roller including a base, a plurality of raised areas located around different circumferential outer portions of the base, a variable weight assembly, wherein is configured to be removably retained within the base, and an end cap having a first slot, wherein the end cap is configured to removably retain the variable weight assembly within the base.

### CROSS-REFERENCE TO RELATED APPLICATIONS

This application is a continuation-in-part of U.S. patent application Ser. No. 17/892,596, filed on Aug. 22, 2022 which is a continuation-in-part of U.S. patent application Ser. No. 29/611,535, filed on Jul. 21, 2017, the disclosures of which are hereby incorporated by reference in their entireties to provide continuity of disclosures to the extent such disclosures are not inconsistent with the disclosure herein.

### FIELD OF THE INVENTION

The present invention is generally related to variable weighted massage rollers. In particular, this invention is directed to a massage roller having variable weights which acts upon the user's muscles of the body by holding the weighted massage roller static, moving the weighted massage roller in different directions or placing the weighted massage roller on a flat solid stable surface, placing the user's body (muscles) on the weighted massage roller and holding the weighted massage roller static or rocking the body over the weighted massage roller.

Furthermore, the invention herein is directed to a massage device that allows the user to independently loosen tight muscles on the body, specifically and most beneficially, the muscles of the shoulder (specifically the upper trapezius), forearms, and thighs (specifically the quadriceps). However, the variable weighted massage roller can be utilized on most other muscles. Furthermore, the user can use the variable weighted massage roller with zero to minimal force.

In one embodiment, the variable weighted massage roller may include a center of the body of the weighted massage roller which, preferably, is the heaviest so that the center of the weighted massage roller can be used to roll over the muscles of the user with zero to minimal force or effort. Furthermore, the concave sections of the variable weighted massage roller allow the user to give less pressure, if desired. Also, the concave sections also allow the user to massage both thighs (when using multiple weighted massage rollers) at once thereby giving less pressure, if desired. Finally, the ends of the variable weighted massage roller are the largest in diameter in order to allow the weighted massage roller to be used as a trigger point device or to pinpoint areas that need to be loosened.

In another embodiment, the variable weighted massage roller may include a plurality of parallel raised areas, wherein each of the plurality of raised areas is located around a different circumferential outer portion of the base of the variable weighted massage roller. In still another embodiment, the variable weighted massage roller may include a removable weight that can be retained within the interior of the weighted massage roller.

### BACKGROUND OF THE INVENTION

Prior to the present invention, as set forth in general terms above and more specifically below, it is known that devices commonly used in self-massaging of the quadriceps tend to be massage sticks that require the user's hands to roll, and apply force; foam rollers wherein the foam roller are placed on the floor such that the user's body is placed on top of the roller in the prone position in order to use the user's body weight to perform the massage action, and massage balls that utilize a ball that is placed on the quadriceps while sitting and using force to roll the ball around. Devices commonly used in self-massage for forearms include massage balls, as stated above. Devices commonly used to self-massage the upper trapezius include S-shaped devices that utilize the user's force and a knobbed end on the S-shaped device that is placed on the muscle.

It is a purpose of this invention to fulfill these and other needs in the massage roller art in a manner more apparent to the skilled artisan once given the following disclosure.

### BRIEF SUMMARY OF THE INVENTION

This invention is directed to a variable weighted massage device that allows the user to independently loosen tight muscles of the body, specifically and most beneficially, the muscles of the shoulder (specifically the upper trapezius), forearms, and thighs (specifically the quadriceps). However, the weighted massage roller can be utilized on most other muscles. Furthermore, the user can use the weighted massage roller with zero to minimal force.

The variable weighted massage roller includes a center of the body of the variable weighted massage roller which, preferably, is the heaviest so that the center of the variable weighted massage roller can be used to roll over the muscles of the user with zero to minimal force or effort. Furthermore, the concave sections of the variable weighted massage roller allow the user to give less pressure, if desired. Also, the concave sections also allow the user to massage both thighs at once (using multiple variable weighted massage rollers) thereby giving less pressure, if desired. Finally, the ends of the variable weighted massage roller are the largest in diameter in order to allow the variable weighted massage roller to be used as a trigger point device or to pinpoint areas that need to be loosened.

In another embodiment, the variable weighted massage roller may include a plurality of parallel raised areas, wherein each of the plurality of raised areas is located around a different circumferential outer portion of the base of the variable weighted massage roller. In still another embodiment, the variable weighted massage roller may include a removable weight that can be retained within the interior of the variable weighted massage roller.

The preferred variable weighted massage roller, according to various embodiments of the present invention, offers the following advantages: ease of use; heaviness in weight; durability; the ability to allow the user to independently loosen tight muscles of the body; the ability to use the variable weighted massage roller with zero to minimal force; the ability to vary the weight of the weighted massage roller; the use of various geometric shapes located around a circumferential portion of the base of the variable weighted massage roller; and the ability to use the massage roller as a trigger point device or to pinpoint areas that need to be loosened. In fact, in many of the preferred embodiments, these advantages are optimized to an extent that is considerably higher than heretofore achieved in prior, known massage rollers.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is an exploded view of a weighted massage roller taken from circle A in FIG. 4, constructed according to the present invention;

FIG. 2 is an end view of the weighted massage roller, constructed according to the present invention;

FIG. 3 is an isometric view of the weighted massage roller, constructed according to the present invention;

FIG. 4 is a side view of the weighted massage roller, constructed according to the present invention;

FIGS. 5A-5E are side views of other embodiments of the variable weighted massage roller, constructed according to the present invention;

FIGS. 6A-6E are end views of various removable end caps for use with the other embodiments of the variable weighted massage roller, constructed according to the present invention; and

FIG. 7 is a schematic illustration of the weights that are configured to be added to the other embodiments of the variable weighted massage roller, constructed according to the present invention.

### DETAILED DESCRIPTION OF THE PREFERRED EMBODIMENTS OF THE INVENTION

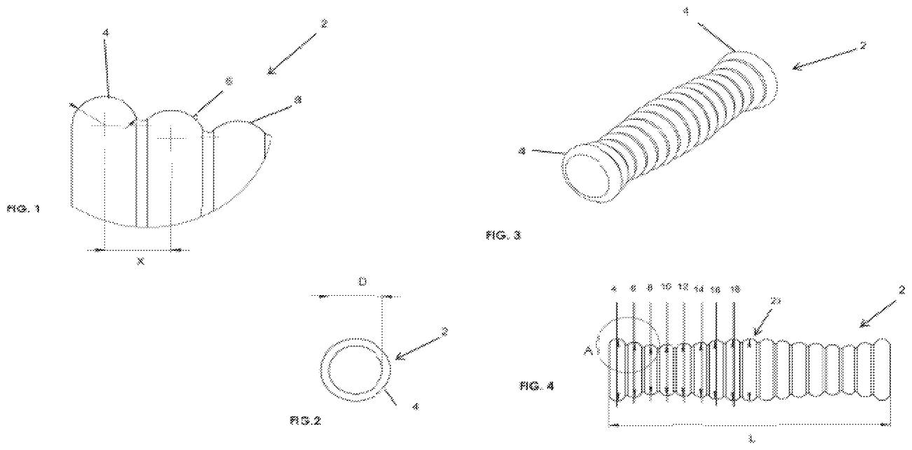

In order to address the shortcomings of the prior, known massage rollers, reference is made now to FIGS. 1-4, where there is illustrated weighted massage roller 2. As will be explained hereinafter in greater detail, the variable weighted massage roller 2 allows the user to independently loosen tight muscles on a user's body, specifically and most beneficially, the muscles of the shoulder (specifically the upper trapezius), forearms, and thighs (specifically the quadriceps). However, the variable weighted massage roller 2 can be utilized on most other muscles. Furthermore, the user can use the variable weighted massage roller 2 with zero to minimal force.

As shown in FIG. 1-4, the variable weighted massage roller 2 includes, in part, end rounds 4, middle rounds 6-18, and center rounds 20. Preferably, variable weighted massage roller 2 can be constructed of any suitable, durable, high strength, stain resistant material such as stainless steel or other similar material. Also, end rounds 4, middle rounds 6-18, and center rounds 20 can be constructed on variable weighted massage roller 2 by conventional techniques such as grinding, milling, forming or the like.

In particular, as shown in FIGS. 1-4, the variable weighted massage roller 2 includes, in part, approximately 17 rounds (4-20) each having varying diameters to give the user specific pressure on designated areas of the human body. Also, the diameters of the rounds (4-20) can be varied depending upon the size of the variable weighted massage roller 2. In particular, a heavier weighted massage roller 2 (i.e., a 10 pound roller) will have overall larger diameter rounds (4-20) when compared to the rounds (4-20) of a lighter weighted massage roller (i.e., a 5-pound roller). Preferably, the diameter (D) range of the rounds 4-20 is as follows:
End round 4-1.98-2.40 cm
Round 6-1.76-2.08 cm
Round 8-1.57-1.81 cm
Round 10-1.63-1.89 cm
Round 12-1.72-2.02 cm
Round 14-1.78-2.11 cm
Round 16-1.88-2.26 cm
Round 18-1.95-2.36 cm
Round 20-1.97-2.39 cm

As shown in FIGS. 1-4, the largest rounds are the end rounds 4 and the center round 20. Preferably, the diameter of the rounds lessens from the end round 4 for two rounds (rounds 6 and 8) with round 8 being the smallest in diameter. The diameter of the rounds then increases until the center round 20. The diameter of the rounds then lessens to the other half of the variable weighted massage roller 2, then decreases in diameter and, finally, increases to the other end round 4. As can be seen in FIGS. 1-4, the opposing sides on each side of center round 20 of variable weighted massage roller 2 are equivalent.

As shown in FIG. 2, the rounds, preferably, are located a distance (X) between each other in order to allow each of the rounds (4-20) to provide the desired massage effect when the variable weighted massage roller 2 is being used. Preferably, the distance (X) can range from 0.47 to 0.67 cm depending upon the size and diameter of the rounds (4-20). Also, the length (L) of the variable weighted massage roller 2 can range from 7.94 to 11.43 cm depending upon the size and weight of the variable weighted massage roller 2.

A unique aspect of the variable weighted massage roller 2 is that it is constructed of a solid heavy metal thereby giving the variable weighted massage roller 2 the necessary weight which will allow the user to not use force when rolling the variable weighted massage roller 2 back and forth over the area to be massaged, however additional force can be utilized. When used independently, the user may also place the variable weighted massage roller 2 on a hard flat surface and then place the body and muscles on top of the variable weighted massage roller 2 in order to utilize the user's body weight as force to get the desired effect. This can either occur by rolling the body of the user on top of the variable weighted massage roller 2 or the variable weighted massage roller 2 can be used without movement for deep pressure and for trigger points. In this manner, the variable weighted massage roller 2 can be placed on the muscle for deep pressure and trigger points or rolled to massage a larger area at once.

A still another unique aspect of the present invention is that the surface of the variable weighted massage roller 2 is smooth in order to allow the user to roll the variable weighted massage roller 2 directly on the skin of the user. In particular, the material that is used in the construction of the variable weighted massage roller 2 is, preferably, a smooth, dense metal (i.e., stainless steel) which allows the user to get a heavier weight in a smaller massage roller.

Another unique aspect of the present invention is that the variable weighted massage roller 2 may be optionally equipped with a heating element or a vibrating mechanism (not shown) in order to provide even further massage benefits.

Another unique aspect of the present invention, as shown in FIG. 1-4, is that the center of the body (rounds 16, 18 and 20) of the variable weighted massage roller 2 is the heaviest which allows the center of the weighted massage roller 2 to roll over the muscles of the user (not shown) while providing zero to minimal force or effort.

A still another unique aspect of the present invention is that the concave sections (rounds 6, 8, 10, 12, and 14) of the variable weighted massage roller 2 allow the user to give less pressure, if desired. The concave sections also allow the user to massage both thighs of the user at once (when using multiple variable weighted massage rollers 2) while giving less pressure, if desired.

An even further unique aspect of the present invention is the end rounds of the variable weighted massage roller 2 which are the largest in diameter(D) in order to allow the variable weighted massage roller 2 to be used as a trigger point device or to pinpoint areas that need to be loosened.

Another unique aspect of the present invention is that one side of the end rounds 4 is flat so that the variable weighted massage roller 2 can stand on end rounds 4.

A still another unique aspect of the present invention is that the variable weighted massage roller 2 can be conventionally heated or cooled in order to provide a desired therapeutic effect during the usage of the variable weighted massage roller 2.

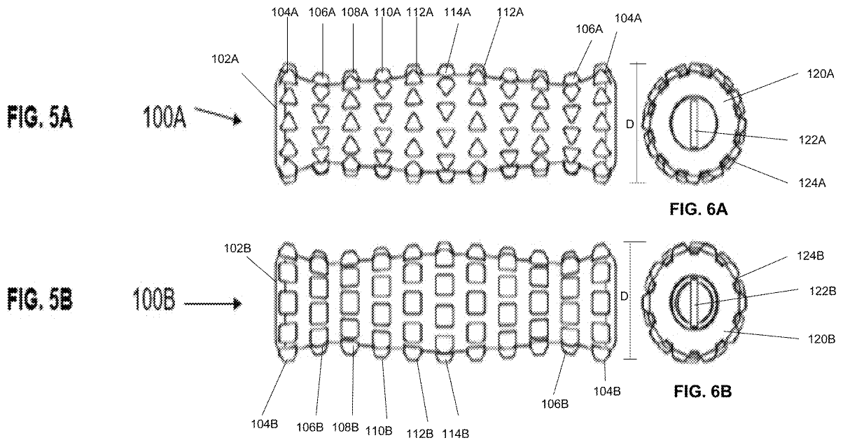

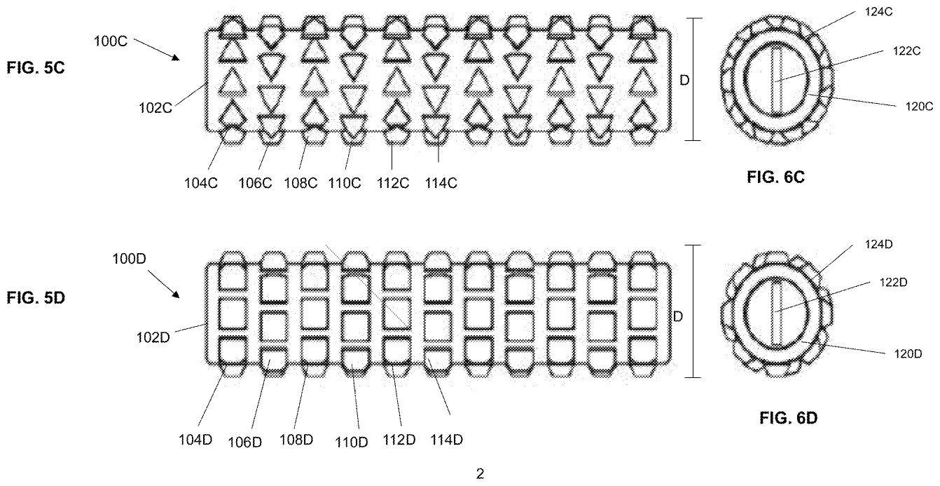

Attention is now directed to FIGS. 5A-5E, 6A-6E, and 7. In particular, as shown in FIGS. 5A-5E, there is illustrated various other embodiments of a variable weighted massage roller. For example, as shown in FIG. 5A, variable weighted massage roller 100A is illustrated. In one embodiment, variable weighted massage roller 100A, includes, in part, base 102A and a plurality of diamond-shaped raised areas 104A-114A located around a different circumferential outer portion of the base 102A of the variable weighted massage roller 100A.

A unique aspect of variable weighted massage roller 100A is that the largest diamond-shaped raised areas 104A-114A in terms of diameter (D) across a circumferential portion of the variable weighted massage roller 100A are the end diamond-shaped raised areas 104A and center diamond-shaped raised area 114A. Preferably, the diameter (D) of the diamond-shaped raised areas lessens from the end diamond-shaped raised area 104A for two diamond-shaped raised areas (diamond-shaped raised areas 106A and 108A) with diamond-shaped raised area 106A having the smallest in diameter. The diameter of the diamond-shaped raised areas then increases until the center diamond-shaped raised area 114A. The diameter of the diamond-shaped raised areas then lessens to the other half of the variable weighted massage roller 100A, then decreases in diameter and, finally, increases to the other end diamond-shaped raised area 104A. As can be seen in FIG. 5A, the opposing sides on each side of center diamond-shaped raised area 114A of variable weighted massage roller 100A are equivalent.

A unique aspect of the variable weighted massage roller 100A is that it is constructed of a solid heavy metal thereby giving the variable weighted massage roller 100A the necessary weight which will allow the user to not use force when rolling the variable weighted massage roller 100A back and forth over the area to be massaged, however additional force can be utilized. When used independently, the user may also place the variable weighted massage roller 100A on a hard flat surface and then place the body and muscles on top of the variable weighted massage roller 100A in order to utilize the user's body weight as force to get the desired effect. This can either occur by rolling the body of the user on top of the variable weighted massage roller 100A or the variable weighted massage roller 100A can be used without movement for deep pressure and for trigger points. In this manner, the variable weighted massage roller 100A can be placed on the muscle for deep pressure and trigger points or rolled to massage a larger area at once.

A still another unique aspect of the present invention is that the surface of the variable weighted massage roller 100A is textured (includes diamond-shaped raised areas 104A-114A) in order to allow the user to roll the variable weighted massage roller 100A directly on the skin of the user. In particular, the material that is used in the construction of the variable weighted massage roller 100A is, preferably, a dense metal (i.e., stainless steel) which allows the user to get a heavier weight in a smaller massage roller size.

Another unique aspect of the present invention is that the variable weighted massage roller 100A may be optionally equipped with a heating element or a vibrating mechanism (not shown) in order to provide even further massage benefits.

Another unique aspect of the present invention, as shown in FIG. 5A, is that the center of the body (diamond-shaped raised areas 112A and 114A) of the weighted massage roller 100A is the heaviest which allows the center of the variable weighted massage roller 100A to roll over the muscles of the user (not shown) while providing zero to minimal force or effort.

A still another unique aspect of the present invention is that the concave sections (diamond-shaped raised area 106A) of the variable weighted massage roller 100A allows the user to give less pressure, if desired. The concave sections also allow the user to massage both thighs of the user at once (when using multiple variable weighted massage rollers 100A) while giving less pressure, if desired.

An even further unique aspect of the present invention is the end diamond-shaped raised areas 104A of the variable weighted massage roller 100A which are the largest in diameter(D) in order to allow the variable weighted massage roller 100A to be used as a trigger point device or to pinpoint areas that need to be loosened.

Another unique aspect of the present invention is that one end of the base 102A adjacent to one of the end diamond-shaped raised areas 104A is flat so that the variable weighted massage roller 100A can stand on the end adjacent to one of the diamond-shaped raised areas 104A.

A still another unique aspect of the present invention is that the variable weighted massage roller 100A can be conventionally heated or cooled in order to provide a desired therapeutic effect during the usage of the variable weighted massage roller 100A.

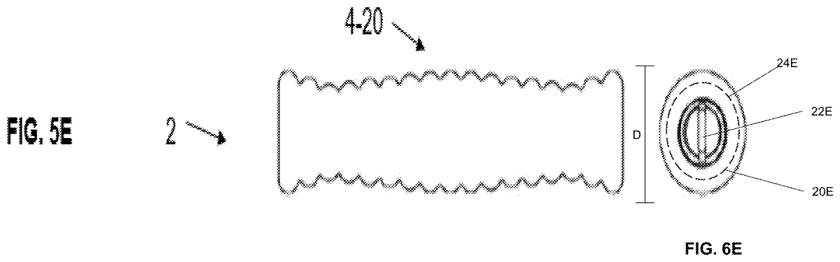

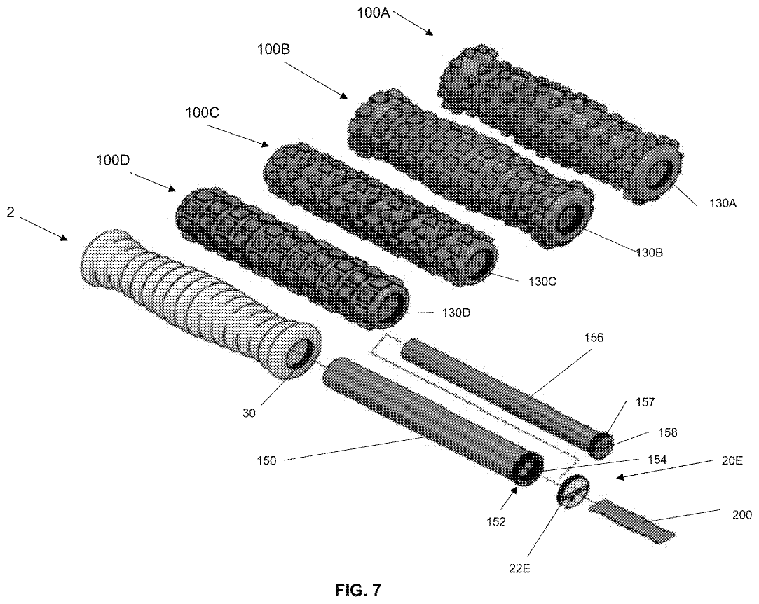

With respect to FIG. 6A, there is illustrated a removable, threaded end cap 120A that can be removably attached to one end of the variable weighted massage roller 100A in order to assist in retaining a variable weight assembly which includes a removable tube 150 and weights 156 (FIG. 7) within variable weighted massage roller 100A, as will be discussed in greater detail later. In one embodiment, the removable, threaded end cap 120A is constructed of a similar material as variable weighted massage roller 100A. Furthermore, removable, threaded end cap 120A includes a slot 122A and threaded area 124A that are formed in removable, threaded end cap 120A by conventional techniques such as molding, printing, forming or the like.

With respect to FIG. 5B, variable weighted massage roller 100B is illustrated. In one embodiment, variable weighted massage roller 100B, includes, in part, base 102B and a plurality of rectangular-shaped raised areas 104B-114B located around a different circumferential outer portion of the base 102B of the variable weighted massage roller 100B.

A unique aspect of variable weighted massage roller 100B is that the largest rectangular-shaped raised areas 104B-114B in terms of diameter (D) across a circumferential portion of the variable weighted massage roller 100B are the end rectangular-shaped raised areas 104B and center rectangular-shaped raised area 114B. Preferably, the diameter (D) of the rectangular-shaped raised areas lessens from the end rectangular-shaped raised area 104B for two rectangular-shaped raised areas (rectangular-shaped raised areas 106B and 108B) with rectangular-shaped raised area 106B being the smallest in diameter. The diameter of the rectangular-shaped raised areas then increases until the center rectangular-shaped raised area 114B. The diameter of the rectangular-shaped raised areas then lessens to the other half of the variable weighted massage roller 100B, then decreases in diameter and, finally, increases to the other end rectangular-shaped raised areas 104B. As can be seen in FIG. 5B, the opposing sides on each side of center rectangular-shaped raised area 114B of weighted massage roller 100B are equivalent.

A unique aspect of the variable weighted massage roller 100B is that it is constructed of a solid heavy metal thereby giving the variable weighted massage roller 100B the necessary weight which will allow the user to not use force when rolling the variable weighted massage roller 100B back and forth over the area to be massaged, however additional force can be utilized. When used independently, the user may also place the variable weighted massage roller 100B on a hard flat surface and then place the body and muscles on top of the variable weighted massage roller 100B in order to utilize the user's body weight as force to get the desired effect. This can either occur by rolling the body of the user on top of the variable weighted massage roller 100B or the variable weighted massage roller 100B can be used without movement for deep pressure and for trigger points. In this manner, the variable weighted massage roller 100B can be placed on the muscle for deep pressure and trigger points or rolled to massage a larger area at once.

A still another unique aspect of the present invention is that the surface of the variable weighted massage roller 100B is textured (includes rectangular-shaped raised areas 104B-114B) in order to allow the user to roll the variable weighted massage roller 100B directly on the skin of the user. In particular, the material that is used in the construction of the variable weighted massage roller 100B is, preferably, a dense metal (i.e., stainless steel) which allows the user to get a heavier weight in a smaller massage roller.

Another unique aspect of the present invention is that the weight variable ed massage roller 100B may be optionally equipped with a heating element or a vibrating mechanism (not shown) in order to provide even further massage benefits.

Another unique aspect of the present invention, as shown in FIG. 5B, is that the center of the body (rectangular-shaped raised areas 112B and 114B) of the variable weighted massage roller 100B is the heaviest which allows the center of the variable weighted massage roller 100B to roll over the muscles of the user (not shown) while providing zero to minimal force or effort.

A still another unique aspect of the present invention is that the concave sections (rectangular-shaped raised area 106B) of the variable weighted massage roller 100B allow the user to give less pressure, if desired. The concave sections also allow the user to massage both thighs of the user at once (when using multiple variable weighted massage rollers 100B) while giving less pressure, if desired.

An even further unique aspect of the present invention is the end rectangular-shaped raised areas 104B of the variable weighted massage roller 100B which are the largest in diameter(D) in order to allow the variable weighted massage roller 100B to be used as a trigger point device or to pinpoint areas that need to be loosened.

Another unique aspect of the present invention is that one end of the base 102B adjacent to one of the end rectangular-shaped raised areas 104B is flat so that the variable weighted massage roller 100B can stand on the end adjacent to the rectangular-shaped raised area 104B.

A still another unique aspect of the present invention is that the variable weighted massage roller 100B can be conventionally heated or cooled in order to provide a desired therapeutic effect during the usage of the variable weighted massage roller 100B.

With respect to FIG. 6B, there is illustrated a removable, threaded end cap 120B that can be removably attached to one end of the variable weighted massage roller 100B in order to assist in retaining a variable weight assembly which includes a removable tube 150 and weights 156 (FIG. 7) within variable weighted massage roller 100B, as will be discussed in greater detail later. In one embodiment, the removable, threaded end cap 120B is constructed of a similar material as variable weighted massage roller 100B. Furthermore, removable, threaded end cap 120B includes a slot 122B and threaded area 124B that are formed in removable, threaded end cap 120B by conventional techniques such as molding, printing, forming or the like.

Regarding FIG. 5C, variable weighted massage roller 100C is illustrated. In one embodiment, variable weighted massage roller 100C, includes, in part, base 102C and a plurality of diamond-shaped raised areas 104A-114A located around a different circumferential outer portion of the base 102C of the variable weighted massage roller 100C. As can be seen in FIG. 5C, the opposing sides on each side of center diamond-shaped raised area 114A of variable weighted massage roller 100C are equivalent.

A unique aspect of the variable weighted massage roller 100C is that it is constructed of a solid heavy metal thereby giving the variable weighted massage roller 100C the necessary weight which will allow the user to not use force when rolling the variable weighted massage roller 100C back and forth over the area to be massaged, however additional force can be utilized. When used independently, the user may also place the variable weighted massage roller 100C on a hard flat surface and then place the body and muscles on top of the variable weighted massage roller 100C in order to utilize the user's body weight as force to get the desired effect. This can either occur by rolling the body of the user on top of the variable weighted massage roller 100C or the variable weighted massage roller 100C can be used without movement for deep pressure and for trigger points. In this manner, the variable weighted massage roller 100C can be placed on the muscle for deep pressure and trigger points or rolled to massage a larger area at once.

A still another unique aspect of the present invention is that the surface of the variable weighted massage roller 100C is textured (includes diamond-shaped raised areas 104C-114C) in order to allow the user to roll the variable weighted massage roller 100C directly on the skin of the user. In particular, the material that is used in the construction of the variable weighted massage roller 100C is, preferably, a dense metal (i.e., stainless steel) which allows the user to get a heavier weight in a smaller massage roller size.

Another unique aspect of the present invention is that the variable weighted massage roller 100C may be optionally equipped with a heating element or a vibrating mechanism (not shown) in order to provide even further massage benefits.

An even further unique aspect of the present invention is the end diamond-shaped raised areas 104C of the variable weighted massage roller 100C allow the variable weighted massage roller 100C to be used as a trigger point device or to pinpoint areas that need to be loosened.

Another unique aspect of the present invention is that one side of the base 102C adjacent to one of the end diamond-shaped raised areas 104C is flat so that the variable weighted massage roller 100C can stand on the end adjacent to diamond-shaped raised area 104C.

A still another unique aspect of the present invention is that the variable weighted massage roller 100C can be conventionally heated or cooled in order to provide a desired therapeutic effect during the usage of the variable weighted massage roller 100C.

With respect to FIG. 6C, there is illustrated a removable, threaded end cap 120C that can be removably attached to one end of the variable weighted massage roller 100C in order to assist in retaining a variable weight assembly which includes a removable tube 150 and weights 156 (FIG. 7) within variable weighted massage roller 100C, as will be discussed in greater detail later. In one embodiment, the removable, threaded end cap 120C is constructed of a similar material as variable weighted massage roller 100C. Furthermore, removable, threaded end cap 120C includes a slot 122C and a threaded area 124C that are formed in removable, threaded end cap 120C by conventional techniques such as molding, printing, forming or the like.

With respect to FIG. 5D, weighted massage roller 100D is illustrated. In one embodiment, weighted massage roller 100D, includes, in part, base 102D and a plurality of rectangular-shaped raised areas 104D-114D located around a different circumferential outer portion of the base 102D of the variable weighted massage roller 100D. As can be seen in FIG. 5B, the opposing sides on each side of center rectangular-shaped raised area 114D of variable weighted massage roller 100D are equivalent.

A unique aspect of the variable weighted massage roller 100D is that it is constructed of a solid heavy metal thereby giving the variable weighted massage roller 100D the necessary weight which will allow the user to not use force when rolling the variable weighted massage roller 100D back and forth over the area to be massaged, however additional force can be utilized. When used independently, the user may also place the variable weighted massage roller 100D on a hard flat surface and then place the body and muscles on top of the variable weighted massage roller 100D in order to utilize the user's body weight as force to get the desired effect. This can either occur by rolling the body of the user on top of the variable weighted massage roller 100D or the variable weighted massage roller 100D can be used without movement for deep pressure and for trigger points. In this manner, the variable weighted massage roller 100D can be placed on the muscle for deep pressure and trigger points or rolled to massage a larger area at once.

A still another unique aspect of the present invention is that the surface of the variable weighted massage roller 100D is textured (includes rectangular-shaped raised areas 104D-114D) in order to allow the user to roll the variable weighted massage roller 100D directly on the skin of the user. In particular, the material that is used in the construction of the variable weighted massage roller 100D is, preferably, a dense metal (i.e., stainless steel) which allows the user to get a heavier weight in a smaller massage roller.

Another unique aspect of the present invention is that the variable weighted massage roller 100D may be optionally equipped with a heating element or a vibrating mechanism (not shown) in order to provide even further massage benefits.

An even further unique aspect of the present invention is the end rectangular-shaped raised areas 104D of the variable weighted massage roller 100D allow the variable weighted massage roller 100D to be used as a trigger point device or to pinpoint areas that need to be loosened.

Another unique aspect of the present invention is that one side of the base 102D adjacent to one of the end rectangular-shaped raised areas 104D is flat so that the variable weighted massage roller 100D can stand on the end adjacent to rectangular-shaped raised areas 104D.

A still another unique aspect of the present invention is that the variable weighted massage roller 100D can be conventionally heated or cooled in order to provide a desired therapeutic effect during the usage of the variable weighted massage roller 100D.

With respect to FIG. 6D, there is illustrated a removable, threaded end cap 120D that can be removably attached to one end of the variable weighted massage roller 100D in order to assist in retaining a variable weight assembly which includes a removable tube 150 and weights 156 (FIG. 7) within variable weighted massage roller 100D, as will be discussed in greater detail later. In one embodiment, the removable, threaded end cap 120D is constructed of a similar material as variable weighted massage roller 100D. Furthermore, removable, threaded end cap 120D includes a slot 122D and a threaded area 124D that are formed in removable, threaded end cap 120D by conventional techniques such as molding, printing, forming or the like.

With respect to FIG. 5E, variable weighted massage roller 2 which is illustrated which is discussed in detail above. As discussed above, the diameter of the rounds lessens from the end round 4 for two rounds (rounds 6 and 8) with round 8 being the smallest in diameter. The diameter of the rounds then increases until the center round 20. The diameter of the rounds then lessens to the other half of the variable weighted massage roller 2, then decreases in diameter and, finally, increases to the other end round 4. As can be seen in FIGS. 1-4, the opposing sides on each side of center round 20 of variable weighted massage roller 2 are equivalent.

With respect to FIG. 6E, there is illustrated a removable, threaded end cap 20E that can be removably attached to one end of the variable weighted massage roller 2 in order to assist in retaining a variable weight assembly which includes a removable tube 150 and weights 156 (FIG. 7) within variable weighted massage roller 2, as will be discussed in greater detail later. In one embodiment, the removable, threaded end cap 20E is constructed of a similar material as variable weighted massage roller 2.

Furthermore, removable, threaded end cap 20E includes a slot 22E and threaded area 24E that is formed in removable, threaded end cap 20E by conventional techniques such as molding, printing, forming or the like.

### Using Variable Weighted Massage Rollers 2-100D

In order to use variable weighted massage rollers 2-100D, attention is directed to FIG. 7. For example, assume that the user wants to add additional weights to variable weighted massage roller 2. It is to be understood that the following description can also be applied to variable weighted massage rollers 100A-100D.

As shown in FIG. 7, in one embodiment, variable weighted massage roller 2 includes threaded end 30. Similarly, variable weighted massage roller 100A includes threaded end 130A, variable weighted massage roller 100B includes threaded end 130B, variable weighted massage roller 100C includes threaded end 130C, and variable weighted massage roller 100D includes threaded end 130D.

As further shown in FIG. 7, a tube 150 having a threaded end 154 located around a perimeter of opening 152 can be used to assist in retaining a weight 156 within tube 150. Weight 156 includes a threaded cap 157 having a slot 158. Preferably, tube 150 and weight 156 are constructed of any suitable, durable, high-strength, rust resistant, UV-resistant material such as stainless steel. It is to be understood that the dimensions and the material used to construct weight 156 can be adjusted in order to change the weight of weight 156.

In order to retain the weight 156 and the tube 150 within the variable weighted massage roller 2, the user slides the weight 156 into tube 150 and secures the weight 156 within the tube 150 through the use of the threaded cap 157 and slot 158. In particular, the end of tool 200 is configured to be able to screw threaded cap 157 onto threaded end 154 of tube 150 using slot 158.

Once the weight 156 has been located and retained within tube 150, tube 150/weight 157 are located within variable weighted massage roller 2. The end of tool 200 is then used to screw end cap 22E through the use of slot 22E onto threaded end 30 of variable weighted massage roller 2 in order to retain the tube 150/weight 157 within variable weighted massage roller 2.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims, and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed.

Accordingly, the description hereinabove is not intended to limit the invention, except as indicated in the appended claims.

Therefore, provided herein are a new and improved weighted massage roller. The preferred weighted massage roller, according to various embodiments of the present invention, offers the following advantages: ease of use; heaviness in weight; durability; the ability to allow the user to independently loosen tight muscles of the body; the ability to use the massage roller with zero to minimal force; the ability to vary the weight of the roller; the use of various geometric shapes located around a circumferential portion of the base of the weighted massage roller; and the ability to use the massage roller as a trigger point device or to pinpoint areas that need to be loosened. In fact, in many of the preferred embodiments, these advantages of ease of use, heaviness in weight, durability, the ability to allow the user to independently loosen tight muscles of the body, the ability to use the massage roller with zero to minimal force, the ability to vary the weight of the roller, the use of various geometric shapes located around a circumferential portion of the base of the weighted massage roller, and the ability to use the massage roller as a trigger point device or to pinpoint areas that need to be loosened are optimized to an extent that is considerably higher than heretofore achieved in prior, known massage rollers.

What is claimed is:

1. A variable weighted massage roller, wherein the roller comprises:
a base having a first opening located at one end of the base;
a plurality of raised areas located around different circumferential outer portions of the base, wherein two of the plurality of raised areas are end raised areas, wherein each of the end raised areas has an end raised area diameter, wherein one of the end raised areas is located adjacent to a flat surface located on the other end of the base, wherein the flat surface is configured to be used to stand the variable weighted massage roller, and wherein the flat surface is also configured to be used to apply a pressure to trigger points on an area to be massaged;
a variable weight assembly, wherein is configured to be removably retained within the base; and
an end cap having a first slot, wherein the end cap is configured to removably retain the variable weight assembly within the base.

2. The variable weighted massage roller, according to claim 1, wherein the plurality of raised areas further comprises:
a plurality of end rounds;
a plurality of middle rounds, wherein one of the plurality of middle rounds is located adjacent to a first one of the plurality of end rounds and a second one of the plurality of middle rounds is located adjacent to a second one of the plurality of end rounds, and wherein each of the plurality of middle rounds has a middle round diameter; and
a center round located adjacent to another of the plurality of middle rounds, wherein the center round has a center round diameter,
wherein the center round diameter is larger than the middle round diameter of each of the plurality of middle rounds and the end round diameter of each of the end rounds is larger than the center round diameter.

3. The variable weighted massage roller, according to claim 1, wherein the plurality of raised areas further comprises:
a plurality of end raised areas;
a plurality of middle raised areas, wherein one of the plurality of middle raised areas is located adjacent to a first one of the plurality of end raised areas and a second one of the plurality of middle raised areas is located adjacent to a second one of the plurality of end raised areas, and wherein each of the plurality of middle raised areas has a middle raised area diameter; and
a center raised area located adjacent to another of the plurality of middle raised areas, wherein the center raised area has a center raised area diameter,
wherein the center raised area diameter is larger than the middle raised area diameter of each of the plurality of middle raised areas and the end raised area diameter of each of the end raised areas is larger than the center raised area diameter.

4. The variable weighted massage roller, according to claim 1, wherein the plurality of raised areas further comprises:
a plurality of diamond-shaped raised areas.

5. The variable weighted massage roller, according to claim 1, wherein the plurality of raised areas further comprises:
a plurality of rectangular-shaped raised areas.

6. The variable weighted massage roller, according to claim 1, wherein the variable weighted massage roller is further comprised of:
stainless steel.

7. The variable weighted massage roller, according to claim 1, wherein the variable weight assembly further comprises:
a tube having a second opening and a threaded end located adjacent to the second opening;
a weight having a threaded cap located at one end of the weight, wherein the threaded cap includes a second slot, wherein the weight is configured to be removably retained within the tube; and
a threaded end located on the first opening, wherein the threaded end located on the first opening is configured to interact with the threaded end cap to removably retain the tube and the weight within the base.

8. The weighted massage roller, according to claim 2, wherein the variable weighted massage roller further comprises:
a smooth surface located on each of the plurality of end rounds, each of the plurality of middle rounds, and the center round.

9. The weighted massage roller, according to claim 1, wherein the plurality of raised areas further comprises:
a plurality of textured raised areas.

10. A method of using a variable weighted massage roller, comprising the steps of:
providing variable weighted massage roller, wherein the variable weighted massage roller further comprises;
a base having a first opening located at one end of the base, and
a plurality of raised areas located around different circumferential outer portions of the base, wherein two of the plurality of raised areas are end raised areas, wherein each of the end raised areas has an end raised area diameter, wherein one of the end raised areas is located adjacent to a flat surface located on the other end of the base, wherein the flat surface is configured to be used to stand the variable weighted massage roller, and wherein the flat surface is also configured to be used to apply a pressure to trigger points on an area to be massaged;
removably retaining a variable weight assembly within the base; and
attaching an end cap having a first slot to the first opening in the base, wherein a tool is configured to interact with the first slot to attach the end cap to the first opening.

11. The method, according to claim 10, wherein the plurality of raised areas further comprises:
a plurality of end rounds;
a plurality of middle rounds, wherein one of the plurality of middle rounds is located adjacent to a first one of the plurality of end rounds and a second one of the plurality of middle rounds is located adjacent to a second one of the plurality of end rounds, and wherein each of the plurality of middle rounds has a middle round diameter; and
a center round located adjacent to another of the plurality of middle rounds, wherein the center round has a center round diameter,
wherein the center round diameter is larger than the middle round diameter of each of the plurality of middle rounds and the end round diameter of each of the end rounds is larger than the center round diameter.

12. The method, according to claim 10, wherein the plurality of raised areas further comprises:
a plurality of end raised areas;
a plurality of middle raised areas, wherein one of the plurality of middle raised areas is located adjacent to a first one of the plurality of end raised areas and a second one of the plurality of middle raised areas is located adjacent to a second one of the plurality of end raised areas, and wherein each of the plurality of middle raised areas has a middle raised area diameter; and
a center raised area located adjacent to another of the plurality of middle raised areas, wherein the center raised area has a center raised area diameter,
wherein the center raised area diameter is larger than the middle raised area diameter of each of the plurality of middle raised areas and the end raised area diameter of each of the end raised areas is larger than the center raised area diameter.

13. The method, according to claim 10, wherein the plurality of raised areas further comprises:
a plurality of diamond-shaped raised areas.

14. The method, according to claim 10, wherein the plurality of raised areas further comprises:
a plurality of rectangular-shaped raised areas.

15. The method, according to claim 10, wherein the variable weighted massage roller is further comprised of:
stainless steel.

16. The method, according to claim 10, wherein the variable weight assembly further comprises:
a tube having a second opening and a threaded end located adjacent to the second opening;
a weight having a threaded cap located at one end of the weight, wherein the threaded cap includes a second slot, wherein the weight is configured to be removably retained within the tube; and
a threaded end located on the first opening, wherein the threaded end located on the first opening is configured to interact with the threaded end cap to removably retain the tube and the weight within the base.

17. The method, according to claim 11, wherein the variable weighted massage roller further comprises:
a smooth surface located on each of the plurality of end rounds, each of the plurality of middle rounds, and the center round.

18. The method, according to claim 10, wherein the plurality of raised areas further comprises:
a plurality of textured raised areas.
